(19) United States
(12) Patent Application Publication
(10) Pub. No.: US 2006/0279792 A1
(43) Pub. Date: Dec. 14, 2006

(54) Pattern overlapping device, method thereof, and program storage medium

(76) Inventors: Taeko Ishizu, Saitama (JP); Hiroshi Shimura, Kanagawa (JP); Masaaki Ishikawa, Tokyo (JP); Haike Guan, Kanagawa (JP); Hiroyuki Yoshida, Tokyo (JP)

Correspondence Address: DICKSTEIN SHAPIRO LLP, 1825 EYE STREET NW, Washington, DC, 20006-5403, US

(21) Appl. No.: 11/438,375

(22) Filed: May 23, 2006

(30) Foreign Application Priority Data
Jun. 10, 2005 (JP) 2005-171061

(51) Int. Cl. H04N 1/40

(52) U.S. Cl. 358/3.28; 358/1.14

(57) ABSTRACT

A pattern overlapping device is disclosed for overlapping a pattern in a sheet-like medium or document data to be printed on the sheet-like medium that enables detection of the pattern without a delay. The pattern overlapping device has an overlapping unit for overlapping the pattern at an edge of the sheet-like medium without deficiency of the shape of the pattern.

### BACKGROUND OF THE INVENTION

1. Field of the Invention

The present invention relates to a pattern overlapping device for overlapping a pattern on a sheet-like medium or in document data to be printed on the sheet-like medium for preventing illegal copying, a pattern overlapping method, a pattern overlapping program, and a storage medium in which the pattern overlapping program is stored.

2. Description of the Related Art

In recent years, because of improvement of performance of image formation techniques, when a copy of a sheet-like bill or a security is made by using a digital color copier, the copy quality is so high that it becomes more and more difficult to distinguish the copied ones from the original ones. For this reason, it is necessary to take measures accordingly, for example, it is supposed to completely prevent copying or to prevent correct copying of the bill, the security, or other special documents.

For example, in a company, even among general documents other than the bills, the securities, or other special documents, there are many confidential documents, copying of which is forbidden from the point of view of preservation of confidentiality. Namely, it is necessary to take measures to completely prevent copying or to prevent correct copying of those confidential documents.

For this purpose, studies have been made extensively to inhibit copying of the above mentioned special documents or the confidential documents.

For example, a technique of distinguishing the bill, the security, or other special documents has been proposed, in which input image data are compared to a pre-registered special mark (pattern data) by means of pattern matching, and when it is found that the special mark exists, it is determined that a document is a special document. For example, Japanese Laid Open Patent Application No. 6-125459 (hereinafter, referred to as “reference 1”) and Japanese Laid Open Patent Application No. 2001-86330 (hereinafter, referred to as “reference 2”) disclose such a technique. Further, when it is determined that a document is a special document, copying of the document is prevented.

Japanese Laid Open Patent Application No. 7-36317 (hereinafter, referred to as “reference 3”) and Japanese Laid Open Patent Application No. 7-87309 (hereinafter, referred to as “reference 4”) disclose a technique of distinguishing a confidential document, copying of which is forbidden, by detecting a mark printed on the confidential document and indicating the confidentiality of the document. This technique makes use of a confidential stamp or mark, which is generally stamped on the confidential document. When it is determined that a document is a confidential document, copying of the document is prohibited.

Japanese Laid Open Patent Application No. 9-164739 (hereinafter, referred to as “reference 5”) and Japanese Laid Open Patent Application No. 2001-197297 (hereinafter, referred to as “reference 6”) disclose a technique of embedding a tint block in an image document to be protected from copying, so as to inhibit illegal copy. This technique is applicable to the image document printed on a piece of paper formed with a tint block pattern on the background of the paper, which pattern has a base area and a message area. The tint block pattern is not noticeable in the image document, and does not influence reading of the image document. However, when the image document embedded with a tint block pattern is copied, for example, the message area of the tint block pattern emerges. For example, in the message area, there is a message of “No Copy”. Seeing this message, it is clear that copying of the document is not allowed, and this imposes psychological restrains on not-allowed copying.

Japanese Laid Open Patent Application No. 2004-274092 (hereinafter, referred to as “reference 7”) discloses a technique of overlapping a pattern (such as a dot pattern) indicating specified information on the surface of a sheet on which an image is to be printed, and when reading the image with an image reader, if the dot pattern is detected, output of the image it prevented.

However, for example, in a device utilizing the technique disclosed in reference 7, which performs control based on detection results of the dot pattern, if the edge of a unit pattern (simply referred to as “pattern” where necessary) of the full pattern (referred to as “a pattern group” where necessary) is not in agreement with the edge of the paper, only a part of the pattern can be detected.

FIG. 1 is a schematic view illustrating the problem of partial overlapping of a pattern group on the paper.

FIG. 1 shows a piece of paper and a pattern group, and the patterns are indicated by dashed lines, with each rectangular area enclosed by dashed lines being a unit pattern (or a pattern).

As shown in FIG. 1, the patterns are not correctly overlapped on the paper, hence, when the paper is read by using a reader in the direction along an arrow shown above the paper, some patterns cannot be detected.

In the technique of controlling the output of an image based on detection results of a dot pattern or the like, depending on the starting position of reading the image, probably, the dot pattern is read from a middle position, and thus not the full pattern group but only part of the pattern is read.

However, since it is not determined that pattern detection is completed until a full pattern comes, when a full pattern comes at the beginning, pattern detection can be finished immediately, but when a part of the pattern comes, it is necessary to determine first whether the dot pattern being detected is a full pattern or not, and continue to read the next dot pattern until a full pattern comes. As a result, compared to the case in which a full pattern comes at the beginning, when a part of the pattern comes, additional operations are necessary, and this causes delay of pattern detection. In other words, when a part of the pattern is detected, the timing of control of preventing the output of the image changes depending on the starting position of reading the image. In practice, this time difference is large, and the detection and control operations are delayed.

In addition, when the pattern includes additional information, detection of the pattern is also delayed.

FIG. 2 is a schematic view illustrating the pattern including additional information.

As shown in FIG. 2, similar to FIG. 1, the patterns including additional information are not correctly overlapped on the paper; hence, when the paper is read by using a reader in the direction along an arrow shown above the paper, some additional information cannot be detected.

### SUMMARY OF THE INVENTION

A general object of the present invention is to solve one or more of the problems of the related art.

A specific object of the present invention is to provide a pattern overlapping device for overlapping a pattern in a sheet-like medium or document data to be printed on the sheet-like medium, which enables detection of the pattern without delay, a pattern overlapping method, a pattern overlapping program, and a storage medium in which the pattern overlapping program is stored.

According to a first aspect of the present invention, there is provided a pattern overlapping method for overlapping a pattern of a predetermined shape on a sheet-like medium or in document data to be printed on the sheet-like medium, comprising:

an overlapping step of overlapping the pattern at an edge of the sheet-like medium without deficiency of the shape of the pattern.

Preferably, the pattern is used for preventing illegal copy of the sheet-like medium.

Preferably, the pattern includes plural pieces of the same additional information used for preventing illegal copying of the sheet-like medium.

According to a second aspect of the present invention, there is provided a pattern overlapping method for overlapping plural rectangular patterns on a rectangular sheet-like medium or in document data to be printed on the sheet-like medium, comprising the step of:

overlapping the rectangular patterns on the rectangular sheet-like medium with sides of the rectangular patterns to be parallel to sides of the rectangular sheet-like medium, the sides of the rectangular patterns having variable length and heights, the rectangular sheet-like medium having a side A of a length W and a side C of a length of H,

wherein

the step of overlapping includes:

a first overlapping step of overlapping one of the patterns having a side B of a length w and a side D of a length h from an edge of the sheet-like medium for a number of [W/2/w] times, where, the bracket [] is a Gaussian notation, and the expression [W/2/w] represents a maximum integer not greater than (W/2/w),

a second overlapping step of overlapping one of the patterns having the side B of a length (W/2 mod w)×2 and a side D of a length h from a position after the first overlapping step is executed, where, the expression (W/2 mod w) represents the smallest positive remainder of (W/2/w), and

a third overlapping step of overlapping one of the patterns having the side B of a length w and a side D of a length h for a number of [(W/2)/w] times from the position after the second overlapping step is executed.

Preferably, the method further includes a determination step, after the third overlapping step, of determining whether the first overlapping step, the second overlapping step, and the third overlapping step are to be executed from a position lowered by a distance of h from the side A in a direction perpendicular to the side A.

Preferably, after the third overlapping step, when next execution of the first overlapping step, the second overlapping step, and the third overlapping step is the {[(H/2)/h]+1}-th overlapping in a direction parallel to the side C, the length of the side D of the rectangular pattern is set to be 2×(H/2 mod h) in the next execution of the first overlapping step, the second overlapping step, and the third overlapping step.

According to a third aspect of the present invention, there is provided a pattern overlapping method for overlapping a pattern of a predetermined shape on a sheet-like medium or in document data to be printed on the sheet-like medium, said pattern including an additional information portion, said method comprising:

an overlapping step of overlapping the additional information portion at an edge of the sheet-like medium without deficiency of the additional information portion.

Preferably, the pattern is used for preventing illegal copying of the sheet-like medium.

Preferably, the pattern includes plural additional information portions.

According to a fourth aspect of the present invention, there is provided a pattern overlapping method for overlapping plural rectangular patterns on a rectangular sheet-like medium or in document data to be printed on the sheet-like medium, comprising the step of:

overlapping the rectangular patterns on the rectangular sheet-like medium with sides of the rectangular patterns to be parallel to sides of the rectangular sheet-like medium, the sides of the rectangular patterns having variable length and heights, the rectangular sheet-like medium having a side A of a length W and a side C of a length of H,

wherein

the step of overlapping includes:

a first overlapping step of overlapping one of the patterns having a side B of a length w and a side D of a length h from an edge of the sheet-like medium for a number of [W/2/w] times,

a second overlapping step of overlapping one of the patterns having the side B of a length (W/2 mod w) and a side D of a length h from a position after the first overlapping step is executed,

a third overlapping step of overlapping one of the patterns having the side B of a length (W/2−r mod w) and a side D of a length h from a position after the second overlapping step is executed, where r is a constant,

a fourth overlapping step of overlapping one of the patterns having the side B of a length w and a side D of a length h for a number of [((W/2)−r)/w] times from the position after the third overlapping step is executed, and

a fifth overlapping step of overlapping one of the patterns with the side B of a length r and a side D of a length h from the position after the fourth overlapping step is executed.

Preferably, the method further includes a determination step, after the fifth overlapping step, of determining whether the first overlapping step, the second overlapping step, the third overlapping step, the fourth overlapping step, and the fifth overlapping step are to be executed from a position lowered by a distance of h from the side A in a direction perpendicular to the side A.

Preferably, after the fifth overlapping step, when the next execution of the first overlapping step, the second overlapping step, the third overlapping step, the fourth overlapping step, and the fifth overlapping step is the {[(H/2)/h]+1}-th overlapping in a direction parallel to the side C, the length of the side D of the rectangular pattern is set to be 2×(H/2 mod h) in the next execution of the first overlapping step, the second overlapping step, the third overlapping step, the fourth overlapping step, and the fifth overlapping step.

According to a fifth aspect of the present invention, there is provided a program executable in a computer for overlapping plural rectangular patterns on a rectangular sheet-like medium or in document data to be printed on the sheet-like medium, said program driving the computer to execute the step of:

overlapping the rectangular patterns on the rectangular sheet-like medium with sides of the rectangular patterns to be parallel to sides of the rectangular sheet-like medium, the sides of the rectangular patterns having variable length and heights, the rectangular sheet-like medium having a side A of a length W and a side C of a length of H,

wherein

the step of overlapping includes:

a first overlapping step of overlapping one of the patterns having a side B of a length w and a side D of a length h from an edge of the sheet-like medium for a number of [W/2/w] times, a second overlapping step of overlapping one of the patterns having the side B of a length (W/2 mod w)×2 and a side D of a length h from a position after the first overlapping step is executed, and

a third overlapping step of overlapping the pattern having the side B of a length w and a side D of a length h for a number of [(W/2)/w] times from the position after the second overlapping step is executed.

According to a sixth aspect of the present invention, there is provided a storage medium including a program executable in a computer for overlapping plural rectangular patterns on a rectangular sheet-like medium or in document data to be printed on the sheet-like medium, said program driving the computer to execute the step of:

overlapping the rectangular patterns on the rectangular sheet-like medium with sides of the rectangular patterns to be parallel to sides of the rectangular sheet-like medium, the sides of the rectangular patterns having variable length and heights, the rectangular sheet-like medium having a side A of a length W and a side C of a length of H,

wherein

the step of overlapping includes:

a first overlapping step of overlapping one of the patterns having a side B of a length w and a side D of a length h from an edge of the sheet-like medium for a number of [W/2/w] times,

a second overlapping step of overlapping one of the patterns having the side B of a length (W/2 mod w)×2 and a side D of a length h from a position after the first overlapping step is executed, and

a third overlapping step of overlapping the pattern having the side B of a length w and a side D of a length h for a number of [(W/2)/w] times from the position after the second overlapping step is executed.

According to a seventh aspect of the present invention, there is provided a pattern overlapping device for overlapping a pattern of a predetermined shape on a sheet-like medium or in document data to be printed on the sheet-like medium, comprising:

an overlapping unit configured to overlap the pattern at an edge of the sheet-like medium without deficiency of the shape of the pattern.

Preferably, the pattern is used for preventing illegal copying of the sheet-like medium.

Preferably, the pattern includes plural pieces of the same additional information used for preventing illegal copying of the sheet-like medium.

According to an eighth aspect of the present invention, there is provided a pattern overlapping device for overlapping plural rectangular patterns on a rectangular sheet-like medium or in document data to be printed on the sheet-like medium, comprising:

an overlapping unit configured to overlap the rectangular patterns on the rectangular sheet-like medium with sides of the rectangular patterns to be parallel to sides of the rectangular sheet-like medium, the sides of the rectangular patterns having variable length and heights, the rectangular sheet-like medium having a side A of a length W and a side C of a length of H,

wherein

the overlapping unit includes:

a first overlapping unit configured to overlap one of the patterns having a side B of a length w and a side D of a length h from an edge of the sheet-like medium for a number of [W/2/w] times,

a second overlapping unit configured to overlap one of the patterns having the side B of a length (W/2 mod w)×2 and a side D of a length h from a position after the first overlapping step is executed, and

a third overlapping unit configured to overlap one of the patterns having the side B of a length w and a side D of a length h for a number of [(W/2)/w] times from the position after the second overlapping step is executed.

Preferably, the pattern overlapping device further includes a determination unit configured to, after the third overlapping unit finishes overlapping, determine whether the first overlapping unit, the second overlapping unit, and the third overlapping unit are to perform overlapping from a position lowered by a distance of h from the side A in a direction perpendicular to the side A.

Preferably, after the third overlapping unit finishes overlapping, when next overlapping operation of the first overlapping unit, the second overlapping unit, and the third overlapping unit is the {[(H/2)/h]+1}-th overlapping operation in a direction parallel to the side C, the length of the side D of the rectangular pattern is set to be 2×(H/2 mod h) in the overlapping operation of the first overlapping unit, the second overlapping unit, and the third overlapping unit.

According to a ninth aspect of the present invention, there is provided a pattern overlapping device for overlapping a pattern of a predetermined shape on a sheet-like medium or in document data to be printed on the sheet-like medium, said pattern including an additional information portion, the pattern overlapping device comprising:

an overlapping unit configured to overlap the additional information portion at an edge of the sheet-like medium without deficiency of the additional information portion.

Preferably, the pattern is used for preventing illegal copying of the sheet-like medium.

Preferably, the pattern includes plural additional information portions.

According to a 10th aspect of the present invention, there is provided a pattern overlapping device for overlapping plural rectangular patterns on a rectangular sheet-like medium or in document data to be printed on the sheet-like medium, comprising:

an overlapping unit configured to overlap the rectangular patterns on the rectangular sheet-like medium with sides of the rectangular patterns to be parallel to sides of the rectangular sheet-like medium, the sides of the rectangular patterns having variable length and heights, the rectangular sheet-like medium having a side A of a length W and a side C of a length of H,

wherein

the overlapping unit includes:

a first overlapping unit configured to overlap one of the patterns having a side B of a length w and a side D of a length h from an edge of the sheet-like medium for a number of [W/2/w] times,

a second overlapping unit configured to overlap one of the patterns having the side B of a length (W/2 mod w) and a side D of a length h from a position after the first overlapping step is executed,

a third overlapping unit configured to overlap one of the patterns having the side B of a length (W/2−r mod w) and a side D of a length h from a position after the second overlapping step is executed, where r is a constant,

a fourth overlapping unit configured to overlap one of the patterns having the side B of a length w and a side D of a length h for a number of [((W/2)−r)/w] times from the position after the third overlapping step is executed, and

a fifth overlapping unit configured to overlap one of the patterns with the side B of a length r and a side D of a length h from the position after the fourth overlapping step is executed.

Preferably, the pattern overlapping device further includes a determination unit configured to, after the fifth overlapping step finishes overlapping, determine whether the first overlapping unit, the second overlapping unit, the third overlapping unit, the fourth overlapping unit, and the fifth overlapping unit are to perform overlapping operation from a position lowered by a distance of h from the side A in a direction perpendicular to the side A.

Preferably, after the fifth overlapping unit finishes overlapping, when next overlapping operation of the first overlapping unit, the second overlapping unit, the third overlapping unit, the fourth overlapping unit, and the fifth overlapping unit is the {[(H/2)/h]+1}-th overlapping operation in a direction parallel to the side C, the length of the side D of the rectangular pattern is set to be 2×(H/2 mod h) in the next overlapping operation of the first overlapping unit, the second overlapping unit, the third overlapping unit, the fourth overlapping unit, and the fifth overlapping unit.

According to the present invention, it is possible to provide a pattern overlapping device for overlapping a pattern in a sheet-like medium or document data to be printed on the sheet-like medium, which enables detection of the pattern without a delay, and provide a pattern overlapping method, a pattern overlapping program, and a storage medium in which the pattern overlapping program is stored.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a schematic view illustrating the problem of partial overlapping of a pattern group on the paper;

FIG. 2 is a schematic view illustrating the pattern including additional information;

FIG. 3 is a block diagram illustrating an example of a pattern overlapping device according to an embodiment of the present invention;

FIG. 4 is a schematic view illustrating a piece of paper printed with patterns by using the pattern overlapping method of the present embodiment;

FIG. 5 is a flowchart illustrating a pattern overlapping method of the present embodiment;

FIG. 6 is a schematic view exemplifying a pattern including additional information;

FIG. 7 is a schematic view explaining a pattern including additional information and being able to be read in different directions;

FIG. 8 shows examples of the pattern including additional information;

FIG. 9 is a schematic view illustrating a piece of paper printed with patterns by using the pattern overlapping method of the present embodiment;

FIG. 10 is a flowchart illustrating a pattern overlapping method of the present embodiment; and

FIG. 11 is a schematic view illustrating a piece of paper printed with the additional information areas on four edges.

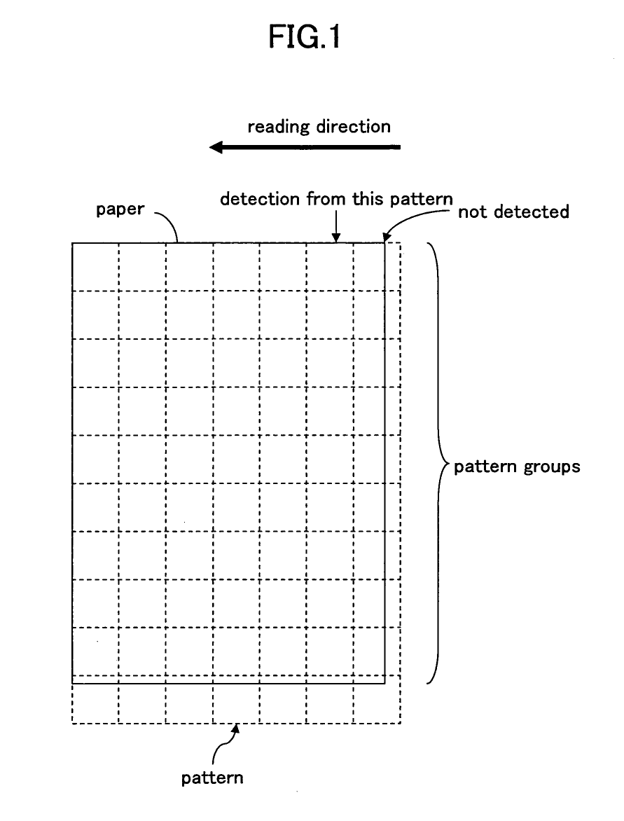

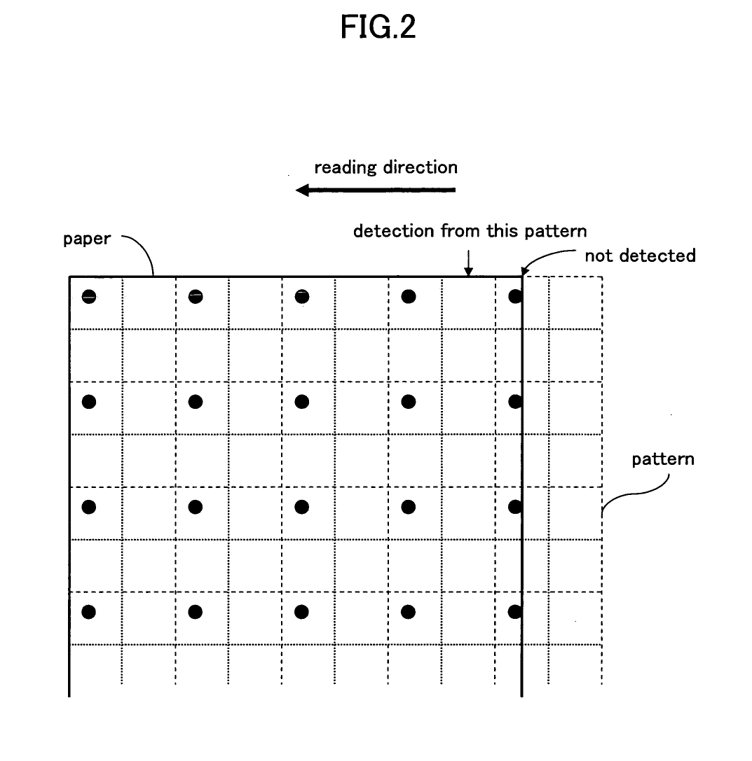

### DESCRIPTION OF THE PREFERRED EMBODIMENTS

Below, preferred embodiments of the present invention are explained with reference to the accompanying drawings.

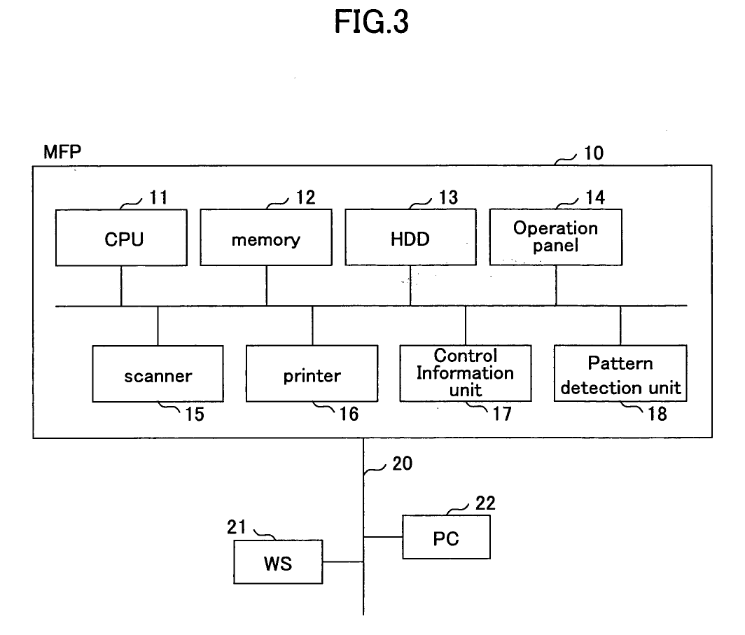

FIG. 3 is a block diagram illustrating an example of a pattern overlapping device according to an embodiment of the present invention.

The device shown in FIG. 3 includes a MFP (Multi-Function Printer) 10, a WS (work station) 21, a PC (personal computer) 22, and a network connecting the MFP 10, the WS 21, and the PC 22.

The MFP 10 includes a CPU 11, a memory 12, a HDD (hard disk) 13, an operation panel 14, a scanner 15, a printer 16, a control information unit 17, and a pattern detection unit 18.

The CPU 11 controls operations of the whole MFP 10. The memory 12 stores programs or data. The HDD 13 stores image data. The operation panel 14 is a user interface (I/F). The scanner 15 inputs an image. The printer 16 outputs an image. The control information unit 17 outputs an input image, and performs image processing required for storing the image. The pattern detection unit 18 detects whether a certain pattern exists in the document to be copied, and when it is detected that the pattern exists, the control information unit 17 stops copying the document.

The control information unit 17 corresponds to the overlapping unit, the first overlapping unit, the second overlapping unit, the third overlapping unit, the fourth overlapping unit, the fifth overlapping unit, and the determination unit in claims.

In the above-mentioned device, a pattern can be overlapped on a sheet by the MFP 10 when the MFP 10 outputs an image on the sheet, or the pattern can be overlapped on document data by a driver of the MFP 10 in the PC 22 or WS 21, which document data are to be printed on the sheet by the MFP 10.

For example, the pattern includes a large number of small dots arranged in a matrix manner, and the pattern is overlapped to prevent illegal copying of the sheet. When the pattern detection unit 18 detects that the pattern exists in the sheet or in the document data, for example, the MFP 10 outputs a black sheet to prevent illegal copying. Of course, the thus overlapped pattern can also be used for purposes other than illegal copy prevention.

Next, the pattern overlapping method is explained.

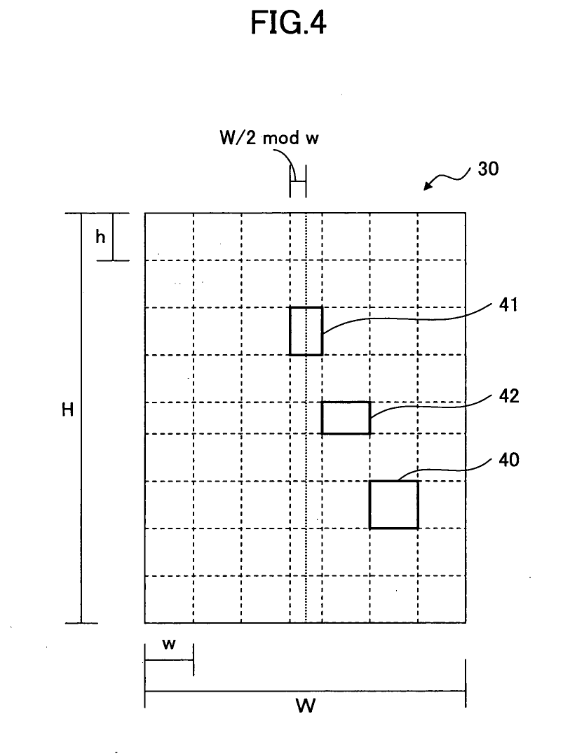

FIG. 4 is a schematic view illustrating a piece of paper printed with patterns by using the pattern overlapping method of the present embodiment.

As shown in FIG. 4, patterns indicated by dashed lines are on a piece of paper 30. Those dashed lines form a number of rectangular areas, each serving as a unit pattern. Among the rectangular areas, a rectangular area 40 has a height of h and a width of w, and is printed on the paper 30 without deficiency of the shape of the rectangular pattern 40.

In contrast, rectangular areas 41 and 42 have different heights or widths from the rectangular pattern 40, and compared to the shape of the rectangular pattern 40, the rectangular areas 41 and 42 are printed on the paper 30 with shape deficiencies. Below, a pattern with a shape deficiency is referred to as “an irregular pattern”, and a pattern without a shape deficiency is referred to as “a regular pattern”.

It should be noted that each unit pattern is illustrated to be a blank rectangle, but actually a large number of dots are arranged in the rectangle.

As shown in FIG. 4, the regular patterns are overlapped (aligned) at edges of the paper 30, and the irregular patterns are overlapped on center lines of the paper 30. When copying the paper 30, because it is from one edge that the paper 30 is read, with the regular patterns being at the edges of the paper 30, as shown in FIG. 4, delay of detection of the patterns is preventable.

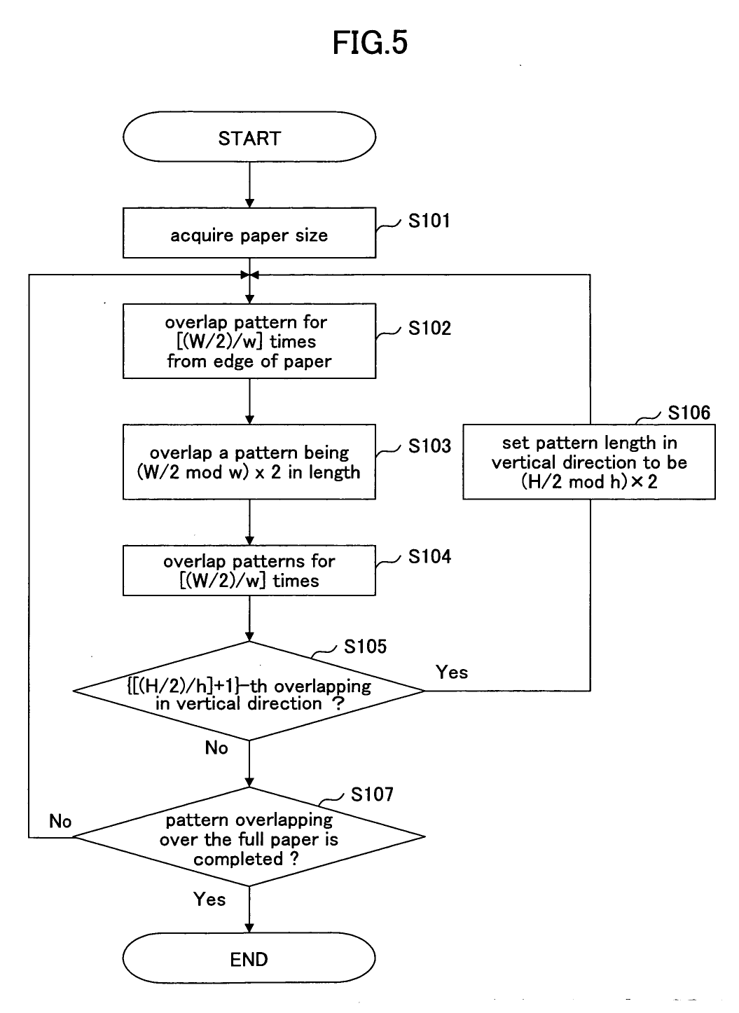

Next, the operation of overlapping patterns on the paper 30 is described with reference to the flowchart in FIG. 5.

FIG. 5 is a flowchart illustrating a pattern overlapping method of the present embodiment.

The operations shown in the flowchart in FIG. 5 includes steps of overlapping a row of patterns on the paper 30 shown in FIG. 4 from the left edge to the right edge (that is, in a horizontal direction), and then overlapping another row of patterns at a position lowered by a distance of h in the vertical direction from the left edge to the right edge, and these steps are repeatedly executed.

In step S101, the size of the paper is acquired. For example, the size of the paper 30 may be specific values such as a height of H and a width of W, as shown in FIG. 4, or, may be known standard values of standard A4 paper or the like.

In step S102, from the left edge of the paper 30, the regular pattern is overlapped for a number of [(W/2)/w] times. As is known, the bracket [] is a Gaussian notation, representing a maximum integer not greater than (W/2)/w. That is, the regular patterns are overlapped in the left half portion of the paper 30 up to a position near the vertical center line of the paper 30.

In step S103, at the position when the pattern overlapping in step S102 is completed, a pattern having a length equaling (W/2 mod w)×2 is overlapped. As known, (A mod B) represents the smallest positive remainder of A/B. In other words, in this step, as shown in FIG. 4, the irregular pattern 41 is overlapped to fill the area near the vertical center line of the paper 30.

In step S104, at the position when the pattern overlapping in step S103 is completed, the regular pattern is overlapped for a number of [(W/2)/w] times. That is, the regular patterns are overlapped in the right half portion of the paper 30 from a position near the vertical center line of the paper 30.

After step S102 through step S104 are executed, one row of patterns (that is, in the horizontal direction) is printed.

In step S105, it is determined whether the next row of the patterns is the {[(H/2)/h]+1}-th row in the vertical direction. That is, it is determined whether the next row is close to the center line in the vertical direction. If the next row is close to the center line, in the next row, the irregular pattern 42 in FIG. 4 should be overlapped.

If the next row is the {[(H/2)/h]+1}-th row in the vertical direction, the routine proceeds to step S106. Otherwise, the routine proceeds to step S107.

In step S106, the height of the pattern (that is, length in the vertical direction) overlapped in the next row is set be (H/2 mod h)×2. Then, the routine returns to step S102.

In step S107, it is determined whether overlapping of the pattern over the full size of the paper 30 is completed. If overlapping of the pattern over the full size of the paper is completed, the routine is finished. Otherwise, the routine returns to step S102 to repeat the steps from S102 to S107.

The above-described steps S102, S103, S104 correspond to the first overlapping step, the second overlapping step, and the third overlapping step, respectively, in claims. The step S107 corresponds to the determination step in claims.

Next, a pattern including additional information is explained. For example, the additional information directs the MFP 10 not to output a black sheet but a sheet of other colors, or other information indicating types of illegal copy prevention. For example, when the MFP 10 performs authentication by using an ID card, if it is identified that the person who is making copies is a person allowed to do that, the additional information directs the MFP 10 to allow the person to make copies.

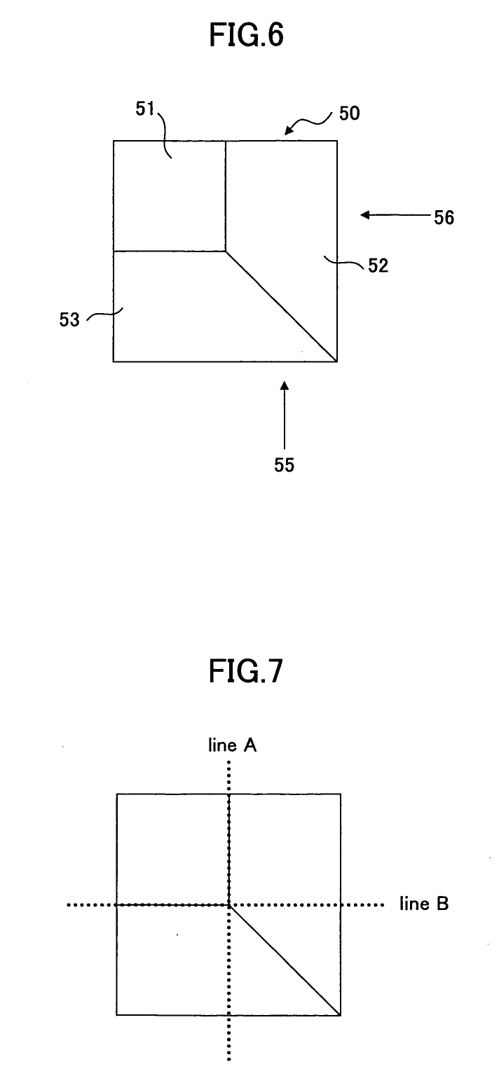

FIG. 6 is a schematic view exemplifying a pattern including additional information.

As shown in FIG. 6, a pattern 50 includes a base portion 51, and additional information portions 52, 53. For example, the additional information portions 52, 53 include the same information. That is, the pattern 50 includes plural pieces of the same additional information.

Because of the presence of plural pieces of the same additional information, no matter whether the pattern 50 is read in either the direction as shown by an arrow 55 or the direction as shown by an arrow 56 in FIG. 6, the additional information can be obtained reliably.

FIG. 7 is a schematic view explaining a pattern including additional information and being able to be read in different directions.

FIG. 7 shows the relative positional relationship between the base portion 51 and the additional information portions 52, 53.

In order to enable reading in different directions, center lines A and B of the pattern in FIG. 7 divide the pattern into four divisions; among the four divisions, if the additional information portions are in the divisions readable in the direction parallel to the line A or B, at least reading in two different directions is possible.

In the example shown in FIG. 6, the arrow 55 is parallel to the line A, and the arrow 56 is parallel to the line B. In the pattern 50, in order that the addition information portions 52, 53 are not split, the pattern 50 can be segmented by the line A or line B as shown in FIG. 7. Due to this, the pattern 50 can be segmented so that at least one of portion of the pattern is not divided, and the pattern can be overlapped so that detection of the pattern is started from the desired additional information.

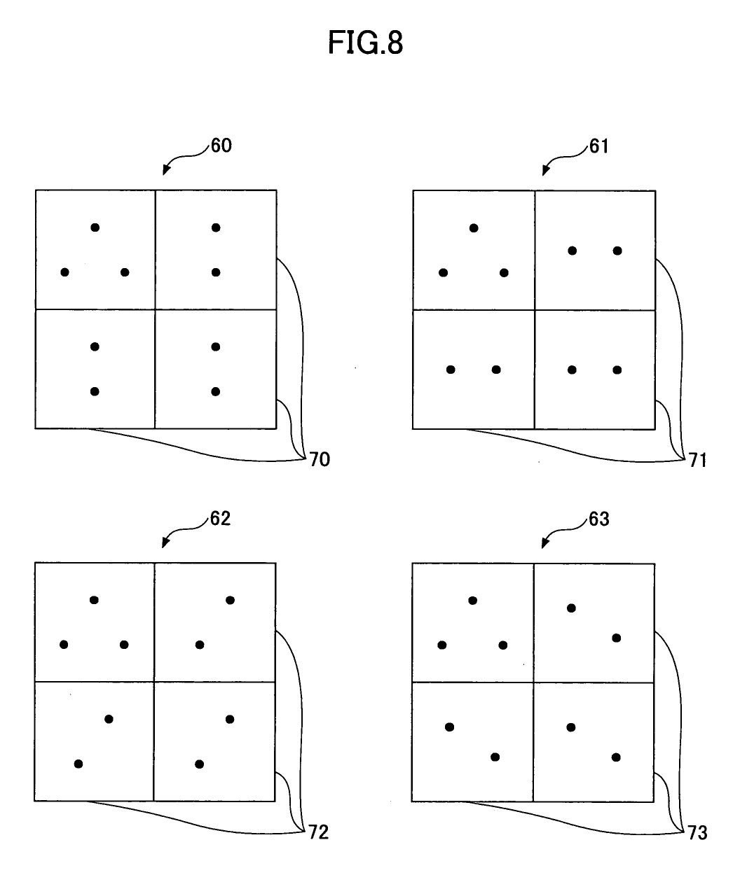

FIG. 8 shows examples of the pattern including additional information.

Four patterns 60, 61, 62, and 63 are shown in FIG. 8. Each of the four patterns 60, 61, 62, and 63 is divided into four rectangular divisions, and three of the four rectangular divisions include additional information.

In the pattern 60, the rectangular divisions 70 include additional information; in the pattern 61, the rectangular divisions 71 include additional information; in the pattern 62, the rectangular divisions 72 include additional information; and in the pattern 63, the rectangular divisions 73 include additional information.

When detecting the patterns 60, 61, 62, and 63, for example, by a combination of divisions including three dots and divisions including two dots, different operations are performed according to the different manner of arranging the two dots. For example, in the pattern 60, the MFP 10 rings to inform people in the surrounding area of the illegal copying. In the pattern 61, the MFP 10 sends an electronic mail to a manager to make a record of the illegal copying. In the pattern 62, the MFP 10 lights a lamp of a manager to inform people in the surrounding area of the illegal copying. In the pattern 63, the MFP 10 takes a log to record the illegal copying. There may be other ways to use the additional information in the pattern.

Next, the method of overlapping the pattern including the additional information is explained.

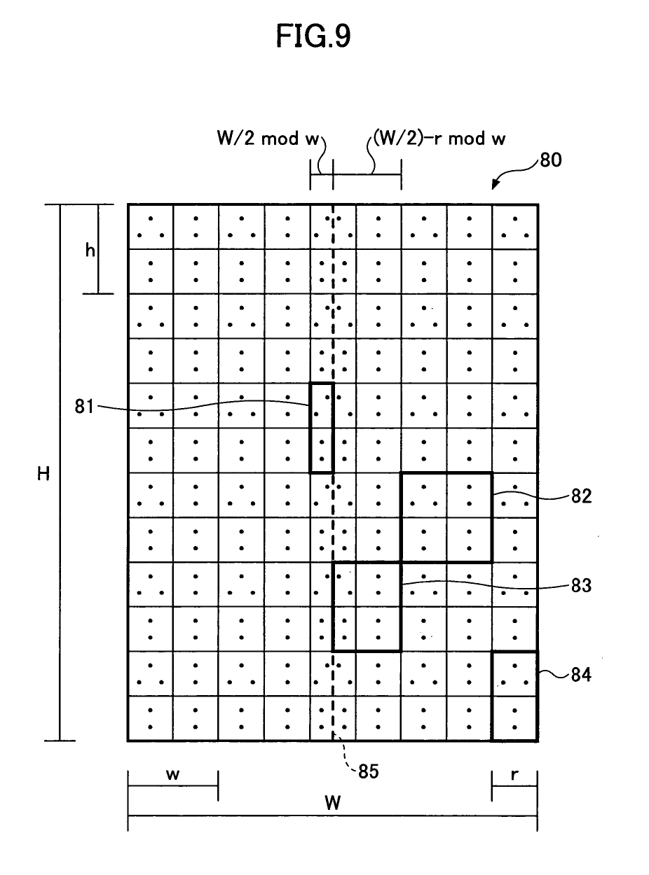

FIG. 9 is a schematic view illustrating a piece of paper printed with patterns by using the pattern overlapping method of the present embodiment.

As shown in FIG. 9, patterns indicated by solid lines are illustrated on a piece of paper 80. Those solid lines form a number of rectangular areas, each serving as a unit pattern. Among the rectangular areas, a rectangular area 82 has a height of h and a width of w, and is printed on the paper 80 without deficiency of the shape of the rectangular pattern 82.

In contrast, rectangular areas 81 and 83 have different heights or widths from the rectangular pattern 82. The rectangular areas 81 and 83 are printed near a center line 85 (dashed line). Compared to the shape of the rectangular pattern 82, the rectangular areas 81 and 83 are printed on the paper 80 with shape deficiencies. Similar to the definition in FIG. 4, patterns 81, 83, which have shape deficiencies, are irregular patterns, and the pattern 82, which does not have a shape deficiency, is a regular pattern.

When making a copy of the paper 80, because it is from one edge that the paper 80 is read, with the regular patterns being printed at the edges of the paper 80, as shown in FIG. 9, delay of detection of the patterns is preventable.

In FIG. 9, there are additional information areas like a rectangular area 84, which includes a rectangle having three dots and a rectangle having two dots. Each of the rectangles has a height of h and a width of r.

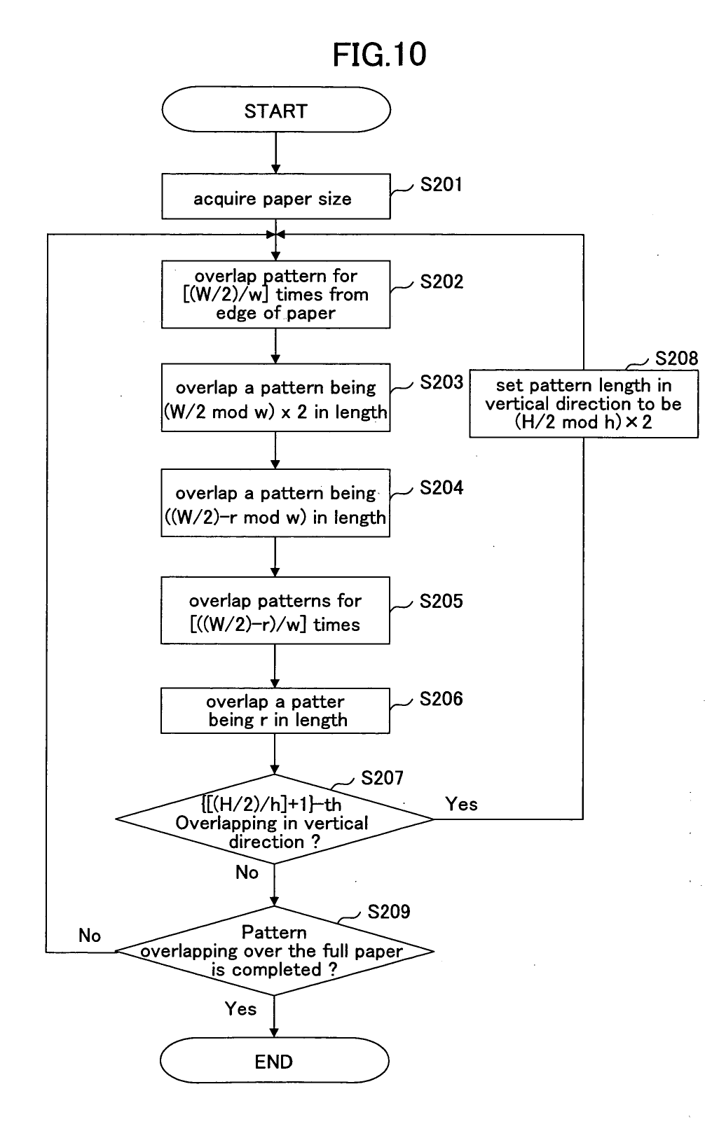

Next, the operation of overlapping patterns on the paper 80 is described with reference to the flowchart in FIG. 10.

FIG. 10 is a flowchart illustrating a pattern overlapping method of the present embodiment.

The operations shown in the flowchart in FIG. 10 includes step of overlapping a row of patterns on the paper 80 shown in FIG. 9 from the left edge to the right edge (that is, in a horizontal direction), and then overlapping the next row of patterns at a position lowered by a distance of h in the vertical direction from the left edge to the right edge, and these steps are repeatedly executed. The difference between FIG. 10 and FIG. 5 is that additional information areas are printed on the edges of the paper 80. Due to this, when reading the paper 80 either from the left edge or from the right edge, it is possible to prevent delay of pattern detection.

In step S201, the size of the paper is acquired. For example, the size of the paper 80 may be specific values such as a height of H and a width of W, as shown in FIG. 9, or, may be known standard values of standard A4 paper or the like.

In step S202, from the left edge of the paper 80, the regular pattern is overlapped for a number of [(W/2)/w] times. As known, the bracket [] is a Gaussian notation, representing a maximum integer not greater than (W/2)/w. That is, the regular patterns are overlapped in the left half of the paper 80 up to a position near the center line 85 of the paper 80.

In step S203, at the position when the pattern overlapping in step S202 is completed, a pattern having a length equaling (W/2 mod w) is overlapped. As known, (A mod B) represents the remainder of A/B. In other words, in this step, as shown in FIG. 9, an irregular pattern the same as the irregular pattern 81 is printed to fill the area on the left side of the vertical center line 85 of the paper 80.

In step S204, at the position when the pattern overlapping in step S203 is completed, a pattern having a length equaling ((W/2)−r mod w) is overlapped. That is, in this step, as shown in FIG. 9, an irregular pattern the same as the irregular pattern 83 is printed to fill the area on the right side of the vertical center line 85 of the paper 80.

In step S205, at the position when the pattern overlapping in step S204 is completed, the regular pattern is overlapped for a number of [((W/2)−r)/w] times. That is, the regular patterns are printed in the right half portion of the paper 80.

In step S206, at the position when the pattern overlapping in step S204 is completed, a pattern having a length equaling r is printed. That is, in this step, an additional information area is printed.

After step S202 through step S206 are executed, one row of patterns (that is, in the horizontal direction) is printed.

In step S207, it is determined whether the next row of the patterns is the {[(H/2)/h]+1}-th row in the vertical direction. That is, it is determined whether the next row is close to the center line in the vertical direction. If the next row is close to the center line, irregular patterns should be overlapped in the next row.

If the next row is the {[(H/2)/h]+1}-th row in the vertical direction, the routine proceeds to step S208. Otherwise, the routine proceeds to step S209.

In step S208, the height of the pattern (that is, length in the vertical direction) overlapped in the next row is set be (H/2 mod h)×2. Then, the routine returns to step S202.

In step S209, it is determined whether printing of the pattern over the full size of the paper 80 is completed. If overlapping of the pattern over the full size of the paper is completed, the routine is finished. Otherwise, the routine returns to step S202 to repeat the steps from S202 to S209.

The above-described steps S202, S203, S204, S205, S206 correspond to the first overlapping step, the second overlapping step, the third overlapping step, the fourth overlapping step, and the fifth overlapping step in claims. The step S209 corresponds to the determination step in claims.

Due to the operations shown in the flowchart in FIG. 10, additional information areas are added at the left edge and the right edge. If the operations shown in the flowchart in FIG. 10 are also executed in the vertical direction, additional information areas can be added at the top edge and the bottom edge without deficiencies.

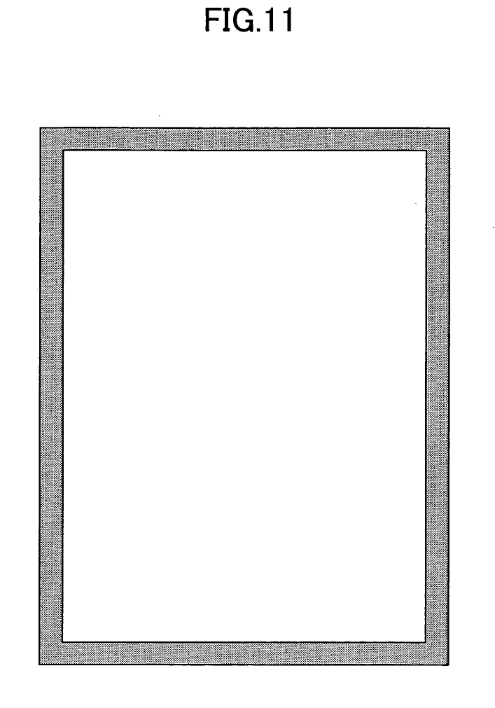

FIG. 11 is a schematic view illustrating a piece of paper printed with the additional information areas on four edges.

In FIG. 11, the additional information areas are indicated to be grey.

In the above descriptions, in order that detection delay does not occur, patterns are printed at edges of the paper without shape deficiencies, or the additional information areas are added. For this purpose, irregular patterns are primarily printed at center portions of the paper, which are far from the edges of the paper.

It should be noted that the present embodiment is not limited to this situation. Specifically, the irregular patterns may be printed at various positions other than the center portions of the paper. When the irregular patterns are printed at a localized area, non-uniformity may be caused by the irregular patterns, or the dots are not uniformly distributed. When the irregular patterns are printed at various positions, such kind of non-uniformity can be reduced.

A program executing the flowchart in FIG. 5 and FIG. 10 can be used as a driver of the MFP 10 or the PC 22. When the program is used as the driver of the MFP 10, the MFP 10 overlaps the pattern during copying or in response to a printing request of the PC 22. When the program is used as the driver of the PC 22, the pattern is embedded in specified document data. In doing so, the pattern overlapping device able to execute the pattern overlapping method of the present invention may correspond to the MFP 10 having a hard disk, or ROM, or other storage media in which the program is stored, or correspond to the PC 22 or the WS 21 having a hard disk or other storage media in which the program is stored.

While the present invention is described above with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Application No. 2005-171061 filed on Jun. 10, 2005, and the entire contents of which are hereby incorporated by reference.

What is claimed is:

1. A pattern overlapping method for overlapping a pattern of a predetermined shape on a sheet-like medium or in document data to be printed on the sheet-like medium, comprising:
an overlapping step of overlapping the pattern at an edge of the sheet-like medium without deficiency of the shape of the pattern.

2. The pattern overlapping method as claimed in claim 1, wherein the pattern is used for preventing illegal copying of the sheet-like medium.

3. The pattern overlapping method as claimed in claim 1, wherein the pattern includes a plurality of pieces of the same additional information used for preventing illegal copying of the sheet-like medium.

4. A pattern overlapping method for overlapping a plurality of rectangular patterns on a rectangular sheet-like medium or in document data to be printed on the sheet-like medium, comprising the step of:
overlapping the rectangular patterns on the rectangular sheet-like medium with sides of the rectangular patterns to be parallel to sides of the rectangular sheet-like medium, the sides of the rectangular patterns having variable lengths and heights, the rectangular sheet-like medium having a side A of a length W and a side C of a length H;, wherein
the step of overlapping includes
a first overlapping step of overlapping one of the patterns having a side B of a length w and a side D of a length h from an edge of the sheet-like medium for a number of [W/2/w] times, where, the bracket [] is a Gaussian notation, and the expression [W/2/w] represents a maximum integer not greater than (W/2/w),
a second overlapping step of overlapping one of the patterns having the side B of a length (W/2 mod w)×2 and the side D of the length h from a position after the first overlapping step is executed, where, the expression (W/2 mod w) represents the smallest positive remainder of (W/2/w), and
a third overlapping step of overlapping one of the patterns having the side B of the length w and the side D of the length h for a number of [(W/2)/w] times from the position after the second overlapping step is executed.

5. The pattern overlapping method as claimed in claim 4, further comprising:
a determination step, after the third overlapping step, of determining whether the first overlapping step, the second overlapping step, and the third overlapping step are to be executed from a position lowered by a distance of h from the side A in a direction perpendicular to the side A.

6. The pattern overlapping method as claimed in claim 4, wherein
after the third overlapping step, when next execution of the first overlapping step, the second overlapping step, and the third overlapping step is the {[(H/2)/h]+1}-th overlapping in a direction parallel to the side C, the length of the side D of the rectangular pattern is set to be 2×(H/2 mod h) in the next execution of the first overlapping step, the second overlapping step, and the third overlapping step.

7. A pattern overlapping method for overlapping a pattern of a predetermined shape on a sheet-like medium or in document data to be printed on the sheet-like medium, said pattern including an additional information portion, said method comprising:
an overlapping step of overlapping the additional information portion at an edge of the sheet-like medium without deficiency of the additional information portion.

8. The pattern overlapping method as claimed in claim 7, wherein the pattern is used for preventing illegal copying of the sheet-like medium.

9. The pattern overlapping method as claimed in claim 7, wherein the pattern includes a plurality of the additional information portions.

10. A pattern overlapping method for overlapping a plurality of rectangular patterns on a rectangular sheet-like medium or in document data to be printed on the sheet-like medium, comprising the step of:
overlapping the rectangular patterns on the rectangular sheet-like medium with sides of the rectangular patterns to be parallel to sides of the rectangular sheet-like medium, the sides of the rectangular patterns having variable lengths and heights, the rectangular sheet-like medium having a side A of a length W and a side C of a length H;,
wherein
the step of overlapping includes
a first overlapping step of overlapping one of the patterns having a side B of a length w and a side D of a length h from an edge of the sheet-like medium for a number of [W/2/w] times, where, the bracket [] is a Gaussian notation, and the expression [W/2/w] represents a maximum integer not greater than (W/2/w),
a second overlapping step of overlapping one of the patterns having the side B of a length (W/2 mod w) and the side D of the length h from a position after the first overlapping step is executed, where, the expression (W/2 mod w) represents the smallest positive remainder of (W/2/w),
a third overlapping step of overlapping one of the patterns having the side B of a length (W/2−r mod w) and the side D of the length h from a position after the second overlapping step is executed, where r is a constant,
a fourth overlapping step of overlapping one of the patterns having the side B of the length w and the side D of the length h for a number of [((W/2)−r)/w] times from the position after the third overlapping step is executed, and
a fifth overlapping step of overlapping one of the patterns with the side B having the length r and the side D of the length h from the position after the fourth overlapping step is executed.

11. The pattern overlapping method as claimed in claim 10, further comprising:
a determination step, after the fifth overlapping step, of determining whether the first overlapping step, the second overlapping step, the third overlapping step, the fourth overlapping step, and the fifth overlapping step are to be executed from a position lowered by a distance of h from the side A in a direction perpendicular to the side A.

12. The pattern overlapping method as claimed in claim 10, wherein
after the fifth overlapping step, when next execution of the first overlapping step, the second overlapping step, the third overlapping step, the fourth overlapping step, and the fifth overlapping step is the {[(H/2)/h]+1}-th overlapping in a direction parallel to the side C, the length of the side D of the rectangular pattern is set to be 2×(H/2 mod h) in the next execution of the first overlapping step, the second overlapping step, the third overlapping step, the fourth overlapping step, and the fifth overlapping step.

13. A program executable in a computer for overlapping a plurality of rectangular patterns on a rectangular sheet-like medium or in document data to be printed on the sheet-like medium, said program driving the computer to execute the step of:
overlapping the rectangular patterns on the rectangular sheet-like medium with sides of the rectangular patterns to be parallel to sides of the rectangular sheet-like medium, the sides of the rectangular patterns having variable lengths and heights, the rectangular sheet-like medium having a side A of a length W and a side C of a length of H;
wherein
the step of overlapping includes
a first overlapping step of overlapping one of the patterns having a side B of a length w and a side D of a length h from an edge of the sheet-like medium for a number of [W/2/w] times,
a second overlapping step of overlapping one of the patterns having the side B of a length (W/2 mod w)×2 and the side D of the length h from a position after the first overlapping step is executed, and
a third overlapping step of overlapping the pattern having the side B of the length w and the side D of the length h for a number of [(W/2)/w] times from the position after the second overlapping step is executed.

14. A storage medium including a program executable in a computer for overlapping a plurality of rectangular patterns on a rectangular sheet-like medium or in document data to be printed on the sheet-like medium, said program driving the computer to execute the step of:
overlapping the rectangular patterns on the rectangular sheet-like medium with sides of the rectangular patterns to be parallel to sides of the rectangular sheet-like medium, the sides of the rectangular patterns having variable lengths and heights, the rectangular sheet-like medium having a side A of a length W and a side C of a length of H;
wherein
the step of overlapping includes
a first overlapping step of overlapping one of the patterns having a side B of a length w and a side D of a length h from an edge of the sheet-like medium for a number of [W/2/w] times, where, the bracket [] is a Gaussian notation, and the expression [W/2/w] represents a maximum integer not greater than (W/2/w),
a second overlapping step of overlapping one of the patterns having the side B of a length (W/2 mod w)×2 and the side D of the length h from a position after the first overlapping step is executed, where, the expression (W/2 mod w) represents the smallest positive remainder of (W/2/w), and
a third overlapping step of overlapping the pattern having the side B of the length w and the side D of the length h for a number of [(W/2)/w] times from the position after the second overlapping step is executed.

15. A pattern overlapping device for overlapping a pattern of a predetermined shape on a sheet-like medium or in document data to be printed on the sheet-like medium, comprising:
an overlapping unit configured to overlap the pattern at an edge of the sheet-like medium without deficiency of the shape of the pattern.

16. The pattern overlapping device as claimed in claim 15, wherein the pattern is used for preventing illegal copying of the sheet-like medium.

17. The pattern overlapping device as claimed in claim 15, wherein the pattern includes a plurality of pieces of the same additional information used for preventing illegal copying of the sheet-like medium.

18. A pattern overlapping device for overlapping a plurality of rectangular patterns on a rectangular sheet-like medium or in document data to be printed on the sheet-like medium, comprising:
an overlapping unit configured to overlap the rectangular patterns on the rectangular sheet-like medium with sides of the rectangular patterns to be parallel to sides of the rectangular sheet-like medium, the sides of the rectangular patterns having variable lengths and heights, the rectangular sheet-like medium having a side A of a length W and a side C of a length of H;
wherein
the overlapping unit includes
a first overlapping unit configured to overlap one of the patterns having a side B of a length w and a side D of a length h from an edge of the sheet-like medium for a number of [W/2/w] times, where, the bracket [] is a Gaussian notation, and the expression [W/2/w] represents a maximum integer not greater than (W/2/w),
a second overlapping unit configured to overlap one of the patterns having the side B of a length (W/2 mod w)×2 and the side D of the length h from a position after the first overlapping step is executed, where, the expression (W/2 mod w) represents the smallest positive remainder of (W/2/w), and
a third overlapping unit configured to overlap one of the patterns having the side B of the length w and the side D of the length h for a number of [(W/2)/w] times from the position after the second overlapping step is executed.

19. The pattern overlapping device as claimed in claim 18, further comprising:
a determination unit configured to, after the third overlapping unit finishes overlapping, determine whether the first overlapping step, the second overlapping step, and the third overlapping step are to be executed from a position lowered by a distance of h from the side A in a direction perpendicular to the side A.

20. The pattern overlapping device as claimed in claim 19, wherein
after the third overlapping unit finishes overlapping, when next overlapping operation of the first overlapping unit, the second overlapping unit, and the third overlapping unit is the {[(H/2)/h]+1}-th overlapping operation in a direction parallel to the side C, the length of the side D of the rectangular pattern is set to be 2×(H/2 mod h) in the overlapping operation of the first overlapping unit, the second overlapping unit, and the third overlapping unit.

21. A pattern overlapping device for overlapping a pattern of a predetermined shape on a sheet-like medium or in document data to be printed on the sheet-like medium, said pattern including an additional information portion, the pattern overlapping device comprising:
an overlapping unit configured to overlap the additional information portion at an edge of the sheet-like medium without deficiency of the additional information portion.

22. The pattern overlapping device as claimed in claim 21, wherein the pattern is used for preventing illegal copy of the sheet-like medium.

23. The pattern overlapping device as claimed in claim 21, wherein the pattern includes a plurality of the additional information portions.

24. A pattern overlapping device for overlapping a plurality of rectangular patterns on a rectangular sheet-like medium or in document data to be printed on the sheet-like medium, comprising:
an overlapping unit configured to overlap the rectangular patterns on the rectangular sheet-like medium with sides of the rectangular patterns to be parallel to sides of the rectangular sheet-like medium, the sides of the rectangular patterns having variable length and heights, the rectangular sheet-like medium having a side A of a length W and a side C of a length of H;
wherein
the overlapping unit includes
a first overlapping unit configured to overlap one of the patterns having a side B of a length w and a side D of a length h from an edge of the sheet-like medium for a number of [W/2/w] times, where, the bracket [] is a Gaussian notation, and the expression [W/2/w] represents a maximum integer not greater than (W/2/w),
a second overlapping unit configured to overlap one of the patterns having the side B of a length (W/2 mod w) and the side D of the length h from a position after the first overlapping step is executed, where, the expression (W/2 mod w) represents the smallest positive remainder of (W/2/w),
a third overlapping unit configured to overlap one of the patterns having the side B of a length (W/2−r mod w) and the side D of the length h from a position after the second overlapping step is executed, where r is a constant,
a fourth overlapping unit configured to overlap one of the patterns having the side B of the length w and the side D of the length h for a number of [((W/2)-r)/w] times from the position after the third overlapping step is executed, and
a fifth overlapping unit configured to overlap one of the patterns with the side B having the length r and the side D of the length h from the position after the fourth overlapping step is executed.

25. The pattern overlapping device as claimed in claim 24, further comprising:
a determination unit configured to, after the fifth overlapping step finishes overlapping, determine whether the first overlapping unit, the second overlapping unit, the third overlapping unit, the fourth overlapping unit, and the fifth overlapping unit are to perform an overlapping operation from a position lowered by a distance of h from the side A in a direction perpendicular to the side A.

26. The pattern overlapping device as claimed in claim 25, wherein
after the fifth overlapping unit finishes overlapping, when the next overlapping operation of the first overlapping unit, the second overlapping unit, the third overlapping unit, the fourth overlapping unit, and the fifth overlapping unit is the {[(H/2)/h]+1}-th overlapping operation in a direction parallel to the side C, the length of the side D of the rectangular pattern is set to be 2×(H/2 mod h) in the next overlapping operation of the first overlapping unit, the second overlapping unit, the third overlapping unit, the fourth overlapping unit, and the fifth overlapping unit.
